(19) United States
(12) Patent Application Publication
(10) Pub. No.: US 2012/0072521 A1
(43) Pub. Date: Mar. 22, 2012

(54) SYSTEM AND METHOD FOR TRACKING EVENTS

(75) Inventors: Declan Goodman, Western Australia (AU); Nils Eric Fredrik Norlin, Stockholm (SE)

(73) Assignee: MOTIFY PTY LTD, South Perth (AU)

(21) Appl. No.: 13/322,738

(22) PCT Filed: May 26, 2010
(86) PCT No.: PCT/AU2010/000639

§ 371 Date: Dec. 7, 2011

(30) Foreign Application Priority Data
May 26, 2009 (AU) 2009902393

(51) Int. Cl. G06F 15/16; H04M 3/42

(52) U.S. Cl. 709/206; 709/204

(57) ABSTRACT

A system for tracking events including a central server and application software provided on mobile communication devices of subscribers. The application software sends current location information of the mobile communication device to the central server via a communication network. A database located on the central server is provided containing subscriber information including contact information for each of the mobile communication devices of subscribers and current and historical location information received from the mobile communication devices. On receiving information regarding the location of an event in a time period, the server sends notifications to those subscribers that were in a zone surrounding said location within said time period providing information regarding the event.

### FIELD OF THE INVENTION

The present invention relates to a system and method for tracking and assessing events including criminal activities and emergency situations.

### BACKGROUND TO THE INVENTION

There are at present a range of initiatives that have been instigated by the police force and governments to encourage members of the public to provide information to assist the police reducing crime. In Australia, the “Crime Stoppers” program advertises information on criminal activities and asks members of the public to come forward with information they believe may be relevant to the police's enquiries. The aim is to increase the public's involvement with the police force and to encourage the public to take a more active role in ensuring their community is crime free.

While such programs are extremely valuable, they usually rely on information on criminal activities provided well after the event has occurred and via blanket alert mechanisms such as radio, newspaper etc which are often not relevant to the majority of people receiving the alert. While the opportunity exists for persons witnessing a crime to contact the police directly, encouraging and coordinating such action is difficult.

The present invention relates to a system aimed at increasing the effectiveness of gathering information in relation to an event such as a crime. The system aims at providing both effective tracking in real time around the period the event occurs as well as providing a useful source of information that can be gathered after the event.

The features of the invention provided for meeting the abovementioned aim also allow the system to be used for real time information gathering and post event assessment of other events such as emergency situations and accidents.

### SUMMARY OF THE INVENTION

According to one aspect of the present invention there is provided a system for tracking events comprising:

a central server;
application software provided on mobile communication devices of subscribers for sending current location information of the mobile communication device to the central server via a communication network;
a database located on the central server, the database containing subscriber information including contact information for each of the mobile communication devices of subscribers and current and historical location information received from the mobile communication devices; and
wherein on receiving information regarding the location of an event in a time period, the server sends notifications to those subscribers that were in a zone surrounding said location within said time period providing information regarding the event.

Preferably the mobile communication devices include GPS functionality and application software, such that the application software transmits current location information to the central server while the application is active.

In a preferred embodiment, the current location information of a subscriber is updated, the system stores the previous location information in the database as historical location information with information regarding the associated time period in which that previous location information was current.

The subscriber application software preferably allows the subscribers to send messages to the central server providing information regarding events at their location.

In one embodiment, notifications in relation to an event are sent to subscribers whose historical location information includes locations within the defined zone around the event location more than a predetermined number of times.

In a preferred embodiment, regions of interest are defined in the database for subscribers and notifications are sent to those subscribers regarding events in said regions of interest regardless of whether the subscriber's current location information indicates they are in said region of interest at the time of the event.

Preferably the information stored for each subscriber identifies other related subscribers and when notifications are sent to a subscriber, notifications are also sent to the related subscribers.

Information regarding multiple mobile communication devices for each subscriber may be stored on the central server and notifications sent to each of the mobile communications devices of the subscriber. Also, each subscriber may designate one or more communication channels over which messages may be sent and notifications are sent over each communication channel.

The communication channels may include SMS, email, IM or Twitter. In one embodiment, notifications are sent via an IP based messaging system.

Preferably the zone is defined based on the type of event.

Preferably an administrator terminal is provided connected to the central server via the Internet. The administrator client software preferably includes a display for displaying maps of zones defined around an event.

According to a further aspect of the present invention, there is provided a method for tracking events comprising the steps of:

sending current location information from mobile communication devices of subscribers to a central server via a communication network;
storing in a database located on the central server subscriber information, including contact information for each of the mobile communication devices of subscribers, and current location information received from the mobile communication devices;
updating the current location information stored in the database for subscribers when further location information is received and storing previous location information in the database as historical location information; and
on receiving information regarding the location of an event in a time period, sending notifications to those subscribers that were in a zone surrounding said location within said time period providing information regarding the event.

Preferably the method includes the further step of receiving messages on the central server sent from subscribers regarding an event. Preferably the method includes the step of defining a subsequent zone based on information received from subscribers.

In one embodiment, notifications are sent in relation to an event to subscribers whose historical location information includes locations within the defined zone around the event location more than a predetermined number of times.

In one embodiment, the method includes the steps of:

storing in the database regions of interest for subscribers; and
sending notifications to subscribers regarding events in said regions of interest regardless of whether the subscriber's current location information indicates they are in said region of interest at the time of the event.

In one embodiment, the method includes the steps of:

storing in the database for each subscriber information regarding other related subscribers; and
sending notifications to the related subscribers when notifications are sent to a subscriber.

### BRIEF DESCRIPTION OF THE DRAWINGS

The invention will now be described, by way of example, with reference to the following drawings in which:

FIG. 1 is a diagram of a system for tracking criminal activities and emergencies in accordance with the present invention;

FIG. 2 is a map showing a first stage of an example of tracking a criminal activity using the system of the present invention;

FIG. 3 is a map showing a second stage of tracking the criminal activity;

FIG. 4 is a map showing a third stage of tracking the criminal activity;

FIG. 5 is a map showing a fourth stage of tracking the criminal activity;

FIG. 6 is a map showing a fifth stage of tracking the criminal activity;

FIG. 7 is a map showing a sixth stage of tracking the criminal activity;

FIG. 8 is a schematic view of the moving zone of a tracking process; and

FIG. 9 is a further system diagram showing communication between the system and relevant parties.

### DETAILED DESCRIPTION OF PREFERRED EMBODIMENTS

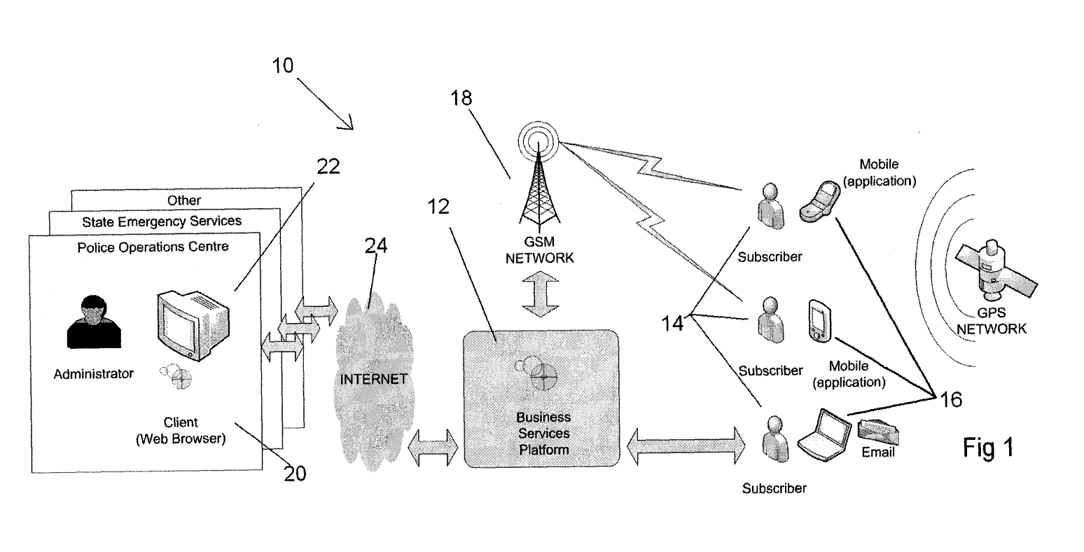

Referring FIG. 1, there is shown a system 10 for tracking criminal activities and emergencies. The system comprises a central server 12 used to communication with a plurality of subscribers 14. Each of the subscribers 14 has a mobile communication device 16 for communication with the system 10. The mobile communication device 16 may comprise a mobile phone, laptop or any other device that includes wireless connection to a communication network. The communication network may comprise an existing mobile phone network 18, such as a GSM network.

Each of the subscribers 16 subscribes to the system 10 by providing information to be stored in a database located on the central server 12. This information includes at least contact information, being information sufficient for a message to be sent to the mobile communication device 16 of the subscriber 14. The contact information may therefore comprise simply a mobile phone number to allow an SMS message to be sent to the phone. That is, in that case the subscriber may remain anonymous. Further information may also be stored, if consented to by the subscriber, including name and address information.

Also, if each subscriber has multiple mobile communication devices, information regarding each device may be stored in the database. Further, each subscriber may designate one or more communication channels over which messages may be sent. For example, messages may be sent via SMS, email, IM, Twitter etc. The subscriber may also designate that messages for them are sent to multiple devices and/or over multiple communication channels. It is expected that in the case of communicating with mobile telephones, an IP based messaging system may be used rather than SMS, in order to reduce the cost of sending messages.

The system also includes a means to obtain current location information in relation to the mobile communication devices 16 of the subscribers 14. In a preferred embodiment, each of the mobile communication devices 16 includes GPS functionality and a subscriber software application. When the subscriber software application is activated by the subscriber, the application sends current location information to the central server via the communication network 18. This subscriber location information is received and stored on the central server 12.

When the current location information of a subscriber is updated, the system also stores the previous location information in the database with information regarding the associated time period in which that previous location information was relevant. The system therefore maintains in the database historical location information in relation to each of the subscribers.

The subscriber software application allows the subscribers 14 to send messages to the central server 12 providing information regarding events such as criminal activities or emergency situations. Further, the system 10 can send via the communication network 18, messages to a selection of subscribers regarding events in their vicinity. When an event is notified to the system, a zone is defined, being a region around the location of the event. The extents of the zone are defined based on the type of event. The system 10 can then send notifications to subscribers whose location information at the time of the event was within said zone.

The system 10 also includes an administrator client 20 to allow a system administrator to monitor and control the operation of the system 10. The administration client 20 may be provided as administrator client software on an administration workstation 22 connected to the central server 12 by a communication network 24, such as the Internet. The administrator may comprise a member of a police force utilising the system for tracking of information relating to criminal activities.

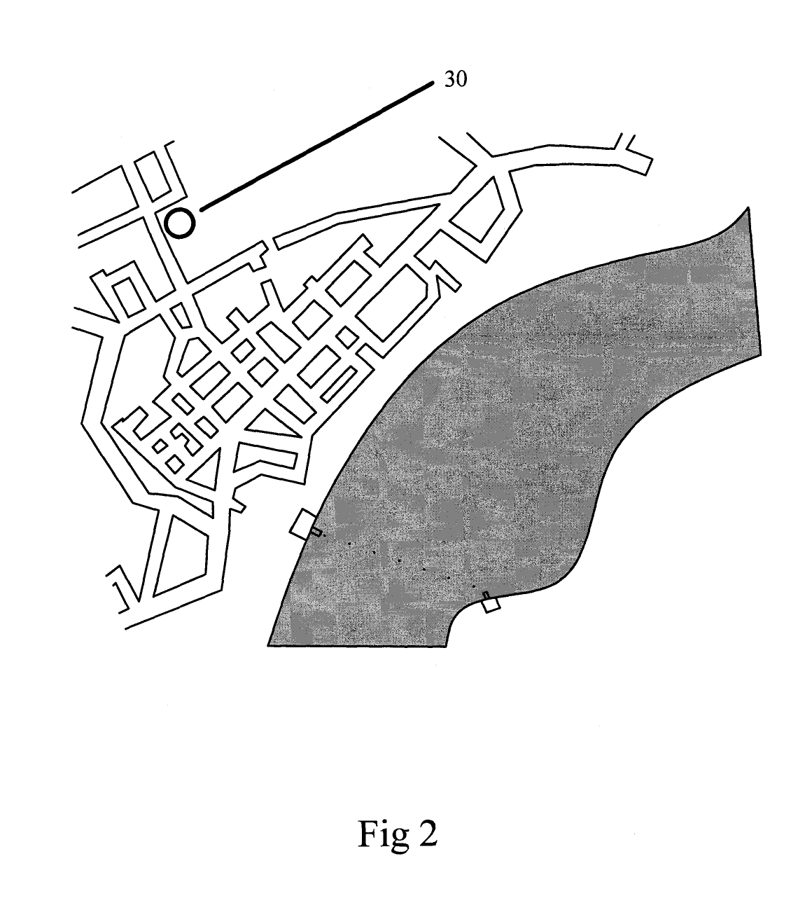

The system 10 may be used for tracking of an event in real time. An example of operation of the system for tracking such a real time event will now be described utilising the case of a crime event, with reference to FIGS. 2 to 7.

In FIG. 2, a criminal event has taken place and this information has been reported to the police. The event may be, for example, a robbery at a particular street location. The event location is provided to the system administrator who records this initial event location via the administrator client terminal along with the time of the event. The information regarding the initial event may be sent by a subscriber 14 of the system 10, or may come from another source.

The administrator client software includes a display for displaying map information such as that shown on FIG. 2. The initial event location is referenced as 30 in this Figure. The information provided is converted to geographical coordinate information and this information is stored by the system.

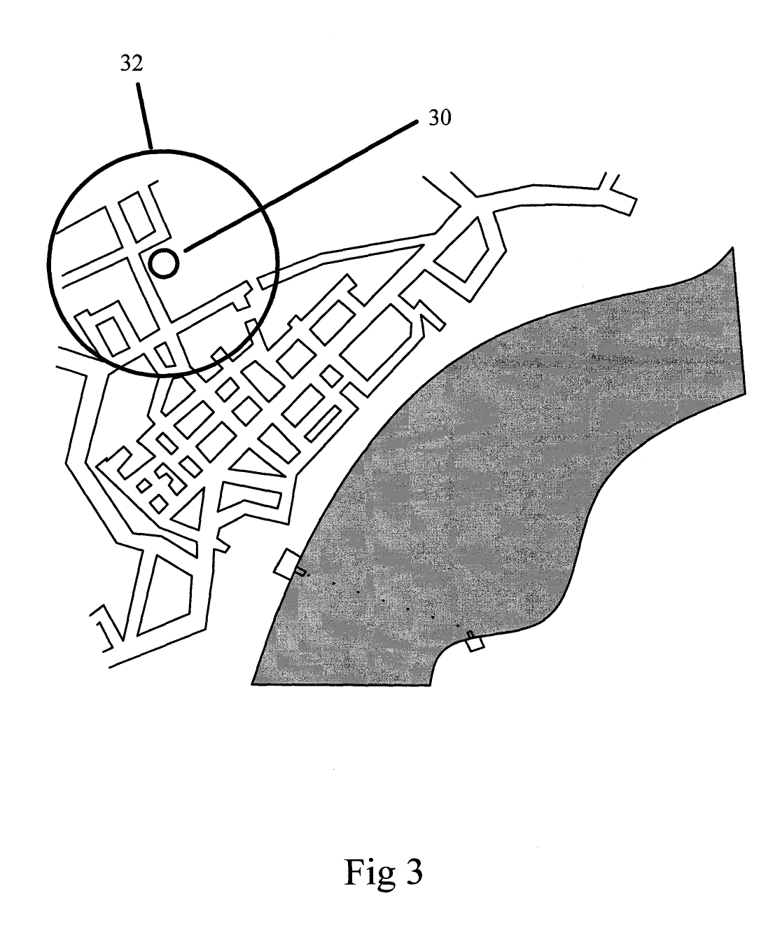

The system then defines an initial zone 32 (as shown in FIG. 3) being a geographical region surrounding the initial event location 30. The extents of the zone are defined based on the type of event. The initial zone 32 in this case is calculated based on information including the time of the event, the current time and the likely distance that the perpetrator may have travelled in the time period. This information may be entered by the administrator as a particular radial distance. Alternatively, the information may be entered into the administrator client and the extents of the zone 32 calculated by the system 10.

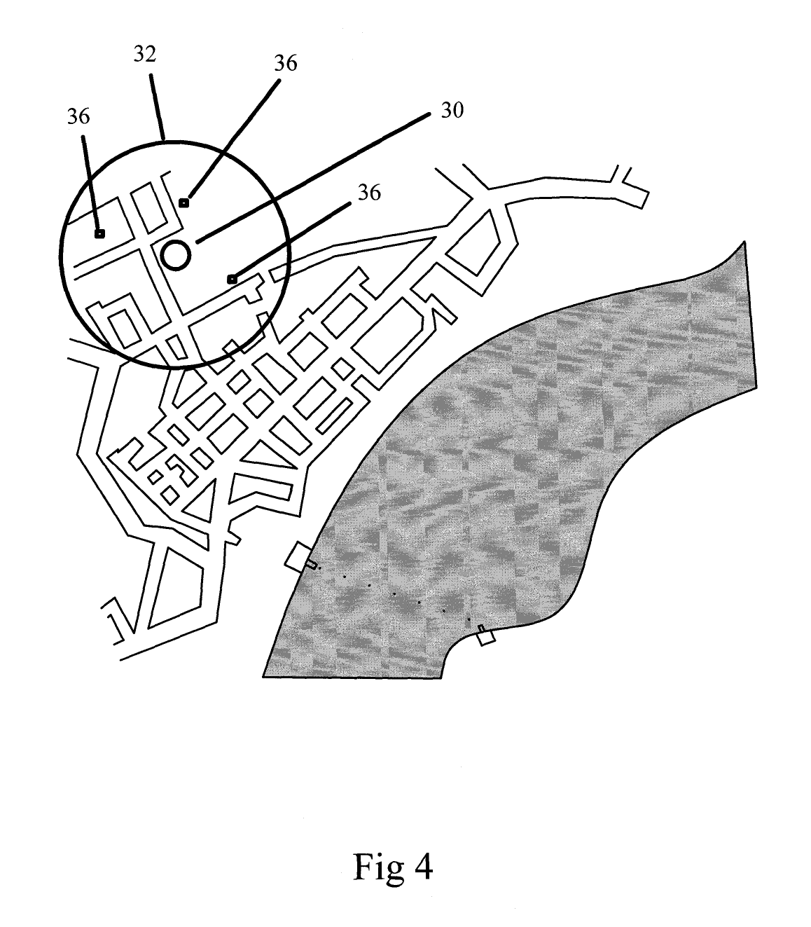

On defining the initial zone 32, the system 10 then compares this geographical information to the current location information of subscribers 14 as stored in the database on the central server 12. This comparison may result in a number of relevant subscribers 36 being located within the initial zone 32 (as shown in FIG. 4). The system 10 then communicates to these relevant subscribers 36 information regarding the criminal event. The information may be entered by the system administrator and then sent by the system 10 to each of the relevant subscribers 36. The mode of communication may be different depending on the communication device 16 of each subscriber 14. In the case of a subscriber with a mobile phone, an SMS message will be sent. The information may, for example, state that a crime has occurred at a particular time and provide the initial location and a description the perpetrator.

If any of the relevant subscribers 36 has further information regarding the crime event, they may communicate this information back to the central server 12 via their mobile communication device 16. The subscriber software may simply allow the subscriber 14 to press a single button or series of buttons to send a message indicating that they have seen the perpetrator. In this way, information can be sent without drawing attention to the subscriber.

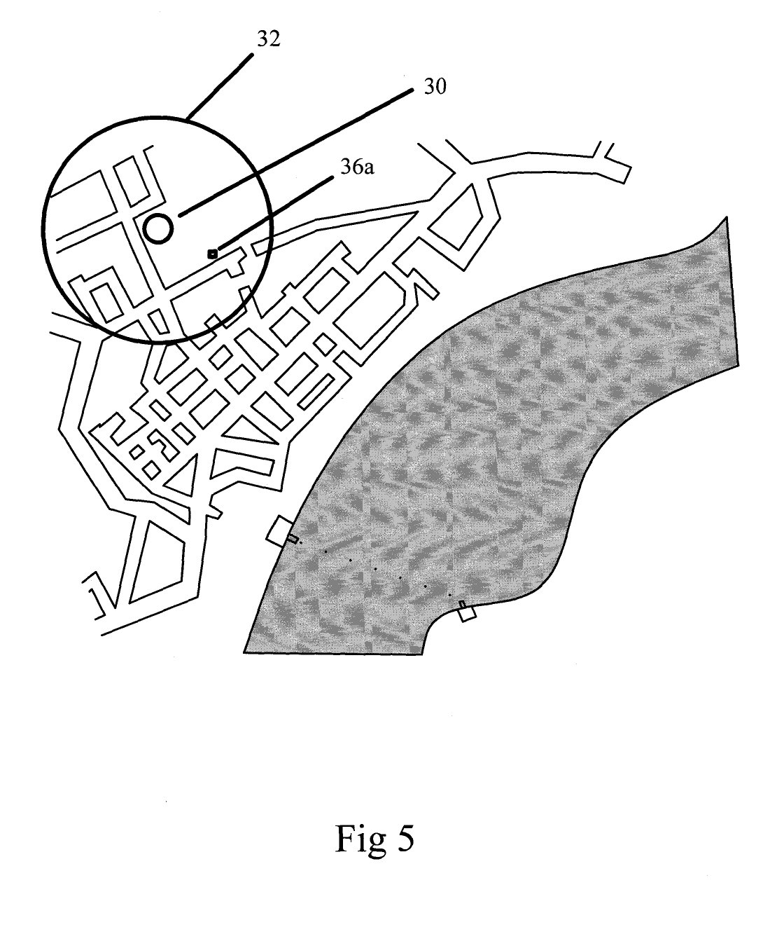

In the example shown, relevant subscriber 36a (as shown in FIG. 5) sends such a message to the central server 12, from which the information can be viewed by the administrator. This information includes the location information obtained by the GPS functionality in the mobile communication device of the relevant subscriber 36a. This information may be communicated to police to enable them to better focus their searches.

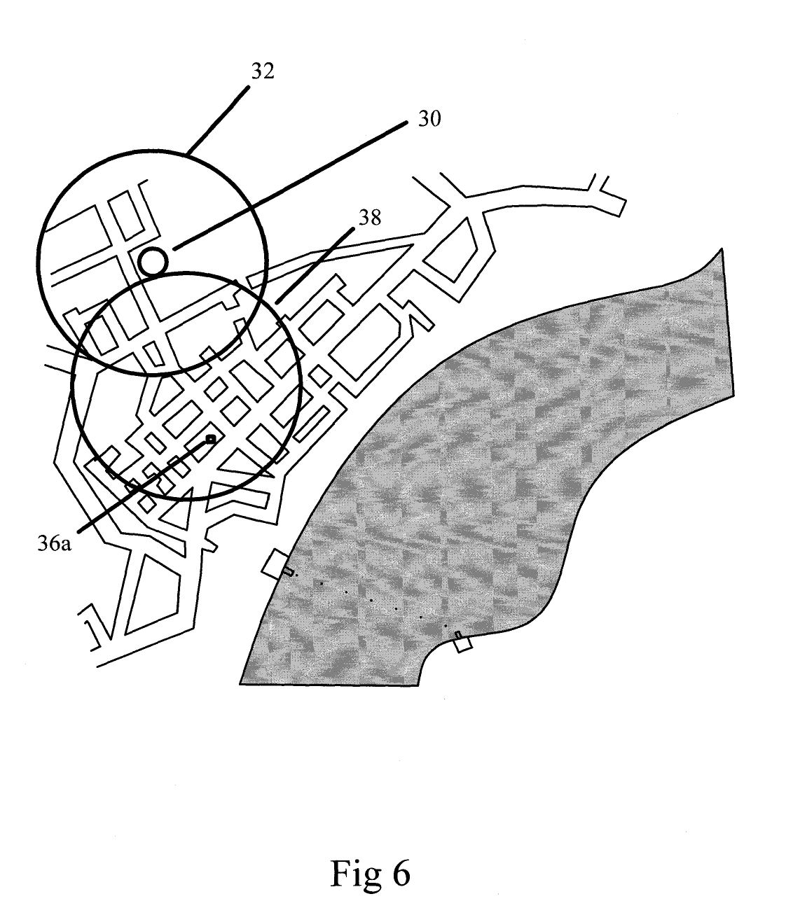

On receiving the further information regarding the subsequent location, the system 10 defines a second zone 38 (as shown in FIG. 6). The second zone 38 is defined in a similar manner to the initial zone but using the subsequent location and time information.

On defining the second zone 38, the system again compares this geographical information to the current location information of subscribers 14 as stored in the database on the central server 12. This comparison may result in the identification of further relevant subscribers being located within the second zone 38. In the example shown, a further relevant subscriber 40 is located (as shown in FIG. 6). The system 10 then communicates to this further relevant subscriber 40 as previously.

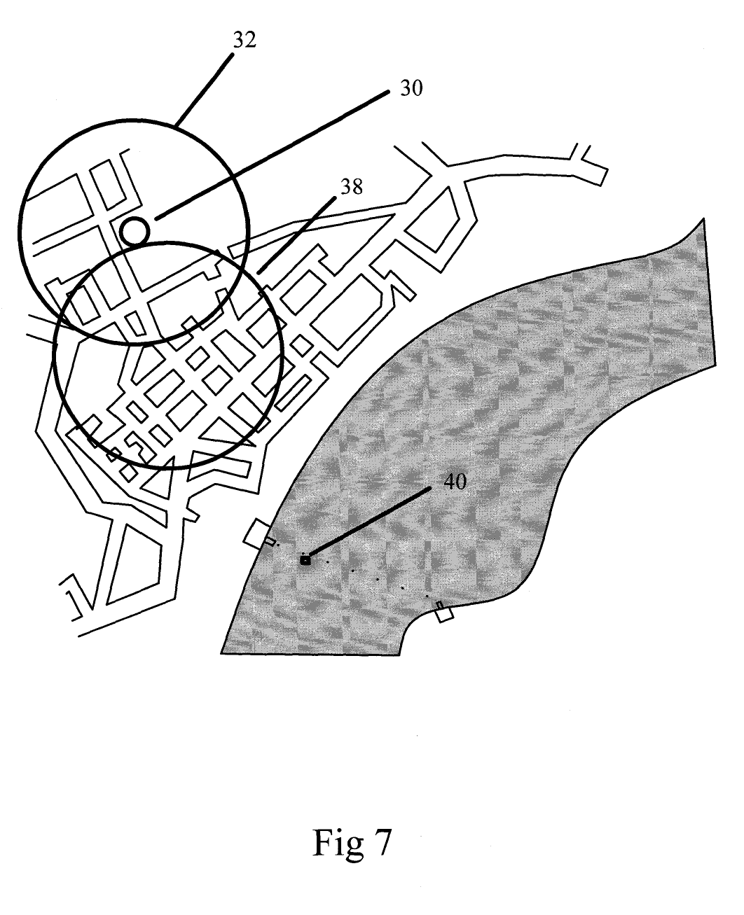

The further relevant subscriber 40 in the example shown has sighted the perpetrator and sends information via their mobile communication device 16 indicating that the perpetrator was seen boarding a ferry to cross the river as shown in FIG. 7. This information is passed by the system administrator who can then alert police to be waiting for the perpetrator at the ferry terminal.

As can be seen, the system of the present invention allows monitoring and tracking of criminal activities in an effective manner. The system makes use of existing infrastructure and therefore implementation costs are kept relatively low. The system also takes advantage of the large number of existing communication devices held by the public to potentially create a large network of information gathering locations.

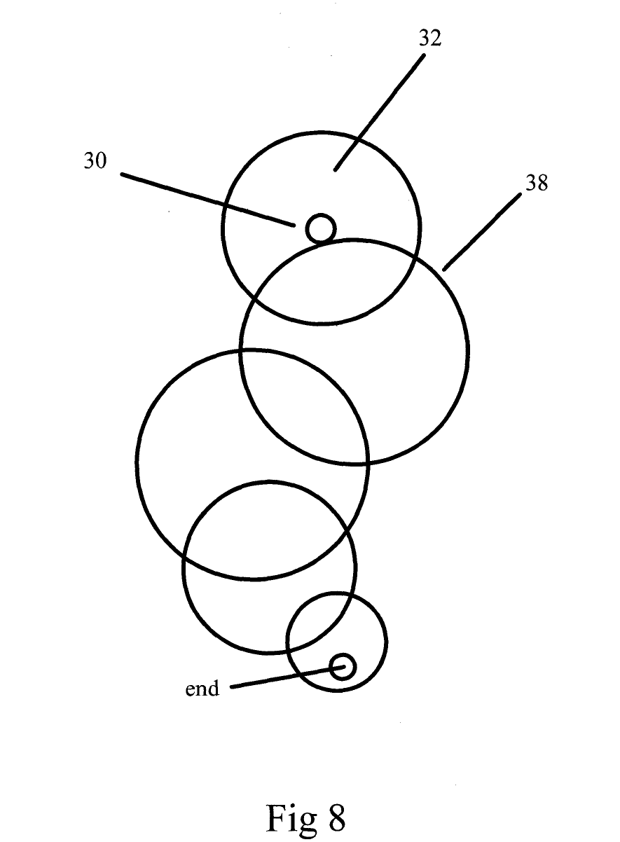

It will be appreciated that the tracking process may progress through any number of stages in which further zones are defined. FIG. 8 shows an example of a set of such further zones defined throughout the tracking process from an initial zone to a conclusion.

In many cases such as crimes, the event is not reported immediately. For example, the original crime may not be witnessed and the event may only come to the attention of authorities at a later time. Alternatively, the crime may be reported but it may later be found that earlier events had occurred related to the crime, the significance of which were not realised at the time.

As the system stores historical location information in relation to the subscribers, the system can be used to retrospectively send notifications to subscribers appealing for information in relation to an event that has occurred. That is, notifications regarding an event may be sent to subscribers whose historical location information indicates that they were in a zone defined around an event within a time period in which the event occurred.

Further, the system may also search the historical location information for locations that are recorded for a subscriber on more than one occasion. That is, locations that are commonly visited by a subscriber. Notifications in relation to an event may then be sent to such subscribers whose historical location information includes locations within the defined zone around the event location more than a predetermined number of times. That is, if a subscriber regularly visited a zone of interest they may be notified of an event in the zone, even though the historical location information for a subscriber does not indicate that the subscriber was in that location at the event time.

For example, if a particular subscriber regularly visits a certain train station, and an event occurred at the train station, a notification may still be sent later to that subscriber as it is possible they were either at the train station but not connected to the system or were there at a different time but still noticed something of importance.

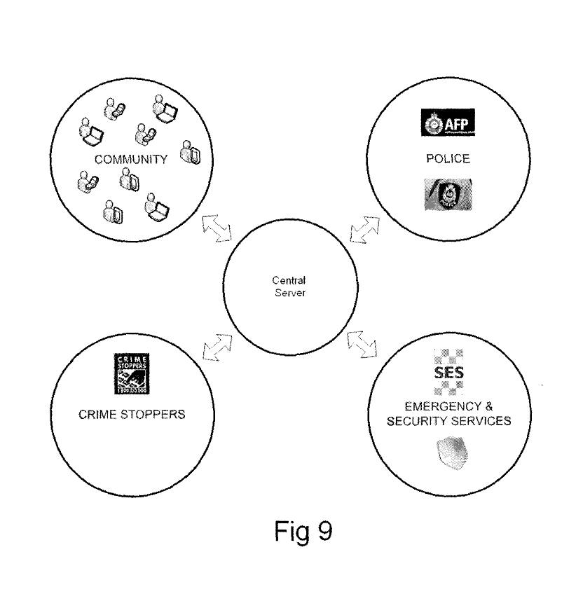

The system may also include the ability for cross communication between administrators of different authorities. FIG. 9 shows a further schematic view of a portion of the system illustrating the use of the system 10 as a central hub for communication between various user groups. For example, if the system administrator of an emergency service received information via the system from a subscriber regarding a traffic accident, the administrator client may allow a notification to be sent via the system to the system administrator for the police to alert also the police force.

While the system has been described using mobile communication devices, it will be appreciated that the system may also be subscribed to by other users having non-portable communication devices, for example personal computers. While gathering information from such devices may be less useful for real-time tracking of events (as the users of such devices may be located elsewhere at the time) it may still provide useful information gathering subsequent to the event occurring.

While the system above has been described in use for tracking criminal activities, it is expected that it may also be used to track other events in which the geographical position of the event is changing. Tracking emergency situations such as bushfires is an example of such an event in which application of the invention may be useful. Further, the historical location information may be useful in order to obtain information to conduct an assessment or investigation into the events that occurred after the fact.

Other features may also be included in the system. For example, when sending information to the system 10, a subscriber 14 may take a digital picture with their mobile communication device 16 and forward this picture to the system 10. For example, should the subscriber see suspicious package on the roadside, an accident or other such event, a picture may be taken and forwarded with the information to the system 10.

Also, each subscriber may designate other regions of interest, information on which is stored in the database. These other regions of interest comprise geographical regions of interest to the subscriber such that, should an event such as a crime or bushfire occur in that zone, they would wish to be notified by the system. Should an event occur in a zone including the region of interest of a subscriber, a notification will be sent to that subscriber regardless of whether their current location information indicates they are in the zone. Such a feature would allow subscribers to be notified if there is a situation of concern to friends, relatives or property within that region of interest.

The system may also be configured such that the information stored for each subscriber identifies other related subscribers. In the event that notifications are sent to a subscriber being in a zone, notification are also sent to the related subscribers. For example, a notification may be sent to the parent of a subscriber if that subscriber is in a particular zone.

As a further feature, the application software on the mobile communication devices may include a personal alarm feature. The personal alarm feature preferably allows an alarm message to be sent to the system on the press of a single button, or a number of simple keystrokes. Preferably holding down a single button for a predetermined time period will activate transmission of the alarm message. This alarm message is then provided to the police or emergency services to indicate that the subscriber is in danger and requires urgent assistance.

It will be readily apparent to persons skilled in the relevant arts that various modifications and improvements may be made to the foregoing embodiments, in addition to those already described, without departing from the basic inventive concepts of the present invention.

1. A system for tracking events comprising:
a central server;
application software provided on mobile communication devices of subscribers for sending current location information of the mobile communication device to the central server via a communication network;
a database located on the central server, the database containing subscriber information further comprising contact information for each of the mobile communication devices of subscribers and both current and historical location information received from the mobile communication devices; and
wherein the server can compare current location information of subscribers to the location of a current event and send information to those subscribers whose current location information indicates they are in a zone surrounding said location, and the server can compare historical location information of subscribers to the location of a past event in a time period and send information to those subscribers whose historical location information indicates they were in a zone surrounding said location in said time period.

2. A system for tracking events according to claim 1, wherein the mobile communication devices include GPS functionality and application software, such that the application software transmits current location information to the central server while the application is active.

3. A system for tracking events according to claim 2, wherein when the current location information of a subscriber is updated, the system stores the previous location information in the database as historical location information with information regarding the associated time period in which that previous location information was current.

4. A system according to claim 1, wherein subscriber application software allows the subscribers to send messages to the central server providing information regarding events at their location.

5. A system for tracking events according to claim 1, wherein notifications in relation to an event are sent to subscribers whose historical location information includes locations within the defined zone around the event location more than a predetermined number of times.

6. A system for tracking events according to claim 1, wherein regions of interest are defined in the database for subscribers and notifications are sent to those subscribers regarding events in said regions of interest regardless of whether the subscriber's current location information indicates they are in said region of interest at the time of the event.

7. A system for tracking events according to claim 1, wherein the information stored for each subscriber identifies other related subscribers and when notifications are sent to a subscriber, notifications are also sent to the related subscribers.

8. A system according to claim 1, wherein information regarding multiple mobile communication devices for each subscriber is stored on the central server and notifications are sent to each of the mobile communications devices of the subscriber.

9. A system claim 1, wherein each subscriber may designate one or more communication channels over which messages may be sent and notifications are sent over each communication channel.

10. A system in accordance with claim 9, wherein the communication channels includes SMS, email, IM or Twitter.

11. A system according to claim 1, wherein notifications are sent via an IP based messaging system.

12. A system according to claim 1, wherein the zone is defined based on the type of event.

13. A system according to claim 1, wherein an administrator terminal is provided connected to the central server via the Internet.

14. A system according to claim 13, wherein an administrator client software comprises a display for displaying maps of zones defined around an event.

15. A method of tracking events comprising:
sending current location information from mobile communication devices of subscribers to a central server via a communication network;
storing in a database located on the central server subscriber information, including contact information for each of the mobile communication devices of subscribers, and current location information received from the mobile communication devices;
updating the current location information stored in the database for subscribers when further location information is received and storing previous location information in the database as historical location information; and
comparing current location information of subscribers to the location of a current event and sending information to those subscribers whose current location information indicates they are in a zone surrounding said location, and comparing historical location information of subscribers to the location of a past event in a time period and sending information to those subscribers whose historical location information indicates they were in a zone surrounding said location in said time period.

16. A method for tracking events according to claim 15, wherein the mobile communication devices comprises application software to transmit current location information to the central server while the application is active.

17. A method for tracking events with according to claim 15, further comprises the step of receiving messages on the central server sent from subscribers regarding an event.

18. A method for tracking events according to claim 17, comprises the step of defining a subsequent zone based on information received from subscribers.

19. A method for tracking events according to claim 15 comprising:
including the step of sending notifications in relation to an event to subscribers whose historical location information includes locations within the defined zone around the event location more than a predetermined number of times.

20. A method for tracking events according to claim 15, comprising:
storing in the database regions of interest for subscribers; and
sending notifications to subscribers regarding events in said regions of interest regardless of whether the subscriber's current location information indicates they are in said region of interest at the time of the event.

21. A method for tracking events according to claim 15, comprising:
storing in the database for each subscriber information regarding other related subscribers; and
sending notifications to the related subscribers when notifications are sent to a subscriber.

22. A method for tracking events according to claim 15, comprising:
sending notifications to multiple mobile communications devices of each subscriber.

23. A method for tracking events according to claim 15, comprising:
sending notifications to subscribers over multiple communication channels.
